(19) United States
(12) Patent Application Publication
(10) Pub. No.: US 2016/0142224 A1
(43) Pub. Date: May 19, 2016

(54) APPARATUS AND METHOD FOR REDUCING THE NUMBER OF PORTS ON WHICH FLOODING IS EXECUTED

(71) Applicant: FUJITSU LIMITED, Kawasaki-shi, Kanagawa (JP)

(72) Inventors: Toshiyuki YOSHIDA, Fukuoka (JP); Masaki Bansho, Fukuoka (JP)

(21) Appl. No.: 14/875,984

(22) Filed: Oct. 6, 2015

(30) Foreign Application Priority Data
Nov. 18, 2014 (JP) 2014-233504

(51) Int. Cl. H04L 12/437; H04L 12/721; H04L 12/931

(52) U.S. Cl. CPC H04L 12/437; H04L 49/351; H04L 45/32

(57) ABSTRACT

A transmission device is connected to other transmission devices in a system configured in a ring topology. The transmission device stores, in a memory, port information items identifying a plurality of output ports connected in the ring topology, in association with each of destination information items, where the plurality of output ports form a redundant configuration and are each configured to transfer a communication signal. The transmission device detects switching information in the system which indicates the port information items related to a change in paths of the ring topology, and, with reference to the memory, executes flooding on output ports associated with the port information items, indicated by the switching information, of the redundant configuration connected in the ring topology.

### CROSS-REFERENCE TO RELATED APPLICATION

This application is based upon and claims the benefit of priority of the prior Japanese Patent Application No. 2014-233504, filed on Nov. 18, 2014, the entire contents of which are incorporated herein by reference.

### FIELD

The embodiment discussed herein is related to apparatus and method for reducing the number of ports on which flooding is executed.

### BACKGROUND

In recent years, the number of cases where Layer 2 switches (hereinafter merely referred to as L2SWs) are operated in a system (International Telecommunication Union Telecommunication Standardization Sector (ITU-T) G.8032 and the like) configured in a ring topology has been increasing. Each L2SW connected in the system configured in the ring topology extracts, from a received frame, a source MAC address (hereinafter merely referred to as MAC-SA) and an input port number. Each L2SW sets the extracted MAC-SA as destination information, sets the extracted input port number as an output port number, and registers the destination information and the output port number in association with each other in a learning table. When an L2SW receives a frame while being operated, the L2SW extracts a destination MAC address (hereinafter merely referred to as MAC-DA) from the received frame. The L2SW searches an output port number associated with the extracted MAC-DA from the learning table. Then, the L2SW transfers the received frame to an output port corresponding to the searched output port number.

In addition, since a path is changed upon system switching due to the occurrence of a failure or upon the update of information of settings within the system, each L2SW connected in the system configured in the ring topology temporarily deletes contents of a learning table. Then, after deleting all the contents of the learning table, each L2SW executes flooding in the overall system, relearns output port numbers for MAC-DAs, and reregisters the output port numbers in the learning table.

An example of related art is Japanese Laid-open Patent Publication No. 2007-181049.

### SUMMARY

According to an aspect of the invention, an apparatus is connected to other apparatuses in a system configured in a ring topology. The apparatus stores, in a memory, port information items identifying a plurality of output ports connected in the ring topology, in association with each of destination information items, where the plurality of output ports form a redundant configuration and are each configured to transfer a communication signal. The apparatus detects switching information in the system which indicates the port information items related to a change in paths of the ring topology, and, with reference to the memory, executes flooding on first output ports associated with the port information items, indicated by the switching information, of the redundant configuration connected in the ring topology.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transmission system according to an embodiment;

FIG. 2 is a diagram illustrating an example of a node, according to an embodiment;

FIGS. 3A and 3B are diagrams illustrating an example of a search table and an example of an output port table, according to an embodiment;

FIG. 4 is a diagram illustrating an example of a transmission system that is operating, according to an embodiment;

FIG. 5 is a diagram illustrating an example of a transmission system when a failure occurs, according to an embodiment;

FIG. 6 is a diagram illustrating an example of a transmission system when a failure is detected, according to an embodiment;

FIG. 7 is a diagram illustrating an example of a transmission system after executing flooding, according to an embodiment;

FIG. 8 is a diagram illustrating an example of an operational flowchart for processing of a node related to a learning process, according to an embodiment;

FIG. 9 is a diagram illustrating an example of an operational flowchart for processing of a node related to an operation process, according to an embodiment;

FIG. 10 is a diagram illustrating an example of an operational flowchart for processing of a node related to a process of detecting a failure, according to an embodiment; and

FIG. 11 is a diagram illustrating an example of a transmission device that executes a transmission program, according to an embodiment.

### DESCRIPTION OF EMBODIMENT

As described above, since each L2SW deletes all the contents of a learning table, flooding may be executed on an undesired port. As a result, a large amount of traffic flows to a port having a low bandwidth assigned thereto due to the flooding, and communication is interrupted due to excessive use of bandwidths. In addition, in recent years, since data whose instantaneous interruption may cause a problem, such as image data or audio data, is included in a communication frame, a mechanism for avoiding such instantaneous interruption as much as possible has been desired.

An aspect aims to provide a transmission device, a transmission system, and a transmission method that may suppress a range to be subjected to flooding to the minimum range.

Hereinafter, an embodiment of a transmission device, a transmission system, and a transmission method that are disclosed herein is described in detail with reference to the accompanying drawings. Techniques disclosed herein, however, are not limited to the embodiment. In addition, at least two of constituent elements or processes described in the embodiment may be combined without causing any contradiction.

### Embodiment

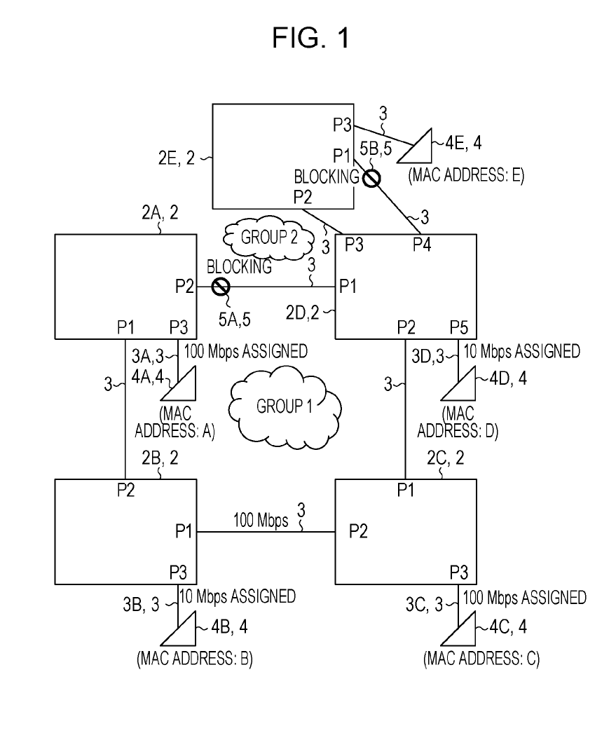

FIG. 1 is a diagram illustrating an example of a transmission system according to the embodiment. A transmission system 1 illustrated in FIG. 1 includes five nodes 2 #1 to 2 #5 connected to each other through a transmission path 3, for example. The nodes 2 are L2SWs, for example. The node 2A #1 includes three ports P1 to P3 and is connected to a terminal device 4A (4) having a MAC address “A” through the port P3 of the node 2A #1, for example. A bit rate that is assigned to a transmission path 3A connecting the port P3 of the node 2A #1 to the terminal device 4A is 100 Mbps, for example. The node 2B #2 includes three ports P1 to P3 and is connected to a terminal device 4B (4) having a MAC address “B” through the port P3 of the node 2B #2, for example. A bit rate that is assigned to a transmission path 3B connecting the port P3 of the node 2B #2 to the terminal device 4B is 10 Mbps, for example. The node 2C #3 includes three ports P1 to P3 and is connected to a terminal device 4C (4) having a MAC address “C” through the port P3 of the node 2C #3, for example. A bit rate that is assigned to a transmission path 3C connecting the port P3 of the node 2C #3 to the terminal device 4C is 100 Mbps, for example. The node 2D #4 includes five ports P1 to P5 and is connected to a terminal device 4D (4) having a MAC address “D” through the port P5 of the node 2D #4, for example. A bit rate that is assigned to a transmission path 3D connecting the port P5 of the node 2D #4 to the terminal device 4D is 10 Mbps, for example. The node 2E #5 includes three ports P1 to P3 and is connected to a terminal device 4E (4) having a MAC address “E” through the port P3 of the node 2E #5, for example.

The node 2A #1, the node 2B #2, the node 2C #3, and the node 2D #4 are connected to each other via a network configured in a ring topology and are classified into a group number G1 identifying the ring topology, for example. For example, the node 2A #1 and the node 2B #2 are connected to each other by connecting the port P1 included in the node 2A #1 to the port P2 included in the node 2B #2 through the transmission path 3. A bit rate that is assigned to the transmission path 3 connecting the nodes 2A and 2B to each other is 100 Mbps, for example. The node 2B #2 and the node 2C #3 are connected to each other by connecting the port P1 included in the node 2B #2 to the port P2 included in the node 2C #3 through the transmission path 3. A bit rate that is assigned to the transmission path 3 connecting the nodes 2B and 2C to each other is 100 Mbps, for example. The node 2C #3 and the node 2D #4 are connected to each other by connecting the port P1 included in the node 2C #3 to the port P2 included in the node 2D #4 through the transmission path 3. A bit rate that is assigned to the transmission path 3 connecting the nodes 2C and 2D to each other is 100 Mbps, for example. The node 2D #4 and the node 2A #1 are connected to each other by connecting the port P1 included in the node 2D #4 to the port P2 included in the node 2A #1 through the transmission path 3. A bit rate that is assigned to the transmission path 3 connecting the nodes 2A and 2D to each other is 100 Mbps, for example.

In the network of the group number G1, a blocking point 5A (5) is set on the transmission path 3 between the node 2A #1 and the node 2D #4 in accordance with a ring protocol, for example. As a result, a loop that extends from the node 2A #1 through the node 2B #2, the node 2C #3, and the node 2D #4 to the node 2A #1 is avoided.

The node 2D #4 and the node 2E #5 are connected to each other in a network configured in a ring topology and are classified into a group number G2 identifying the ring topology, and the ring topology identified by the group number G2 is separated from the ring topology identified by the group number G1. For example, the node 2D #4 and the node 2E #5 are connected to each other by connecting the port P3 included in the node 2D #4 to the port P2 included in the node 2E #5 through the transmission path 3. In addition, the node 2D #4 and the node 2E #5 are connected to each other by connecting the port P4 included in the node 2D #4 to the port P1 included in the node 2E #5 through the transmission path 3. In the network of the group number G2, a blocking point 5B (5) is set on the transmission path 3 between the port P4 included in the node 2D #4 and the port P1 included in the node 2E #5 in accordance with a ring protocol, for example.

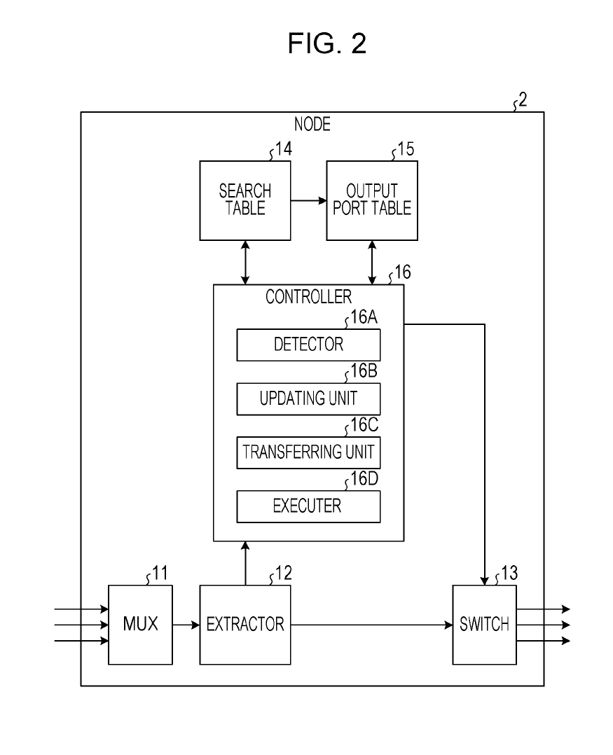

FIG. 2 is a diagram illustrating an example of the nodes 2. A node 2 illustrated in FIG. 2 includes a multiplexer (MUX) 11, an extractor 12, a switch 13, a search table 14, an output port table 15, and a controller 16. The MUX 11 multiplexes frames received through input ports P included in the node 2. In addition, the MUX 11 adds port numbers identifying the input ports P to header information included in the frames. The extractor 12 extracts MAC-SAs, MAC-DAs, and input port numbers from the frames. The switch 13 outputs the received frames to output ports P corresponding to set port numbers.

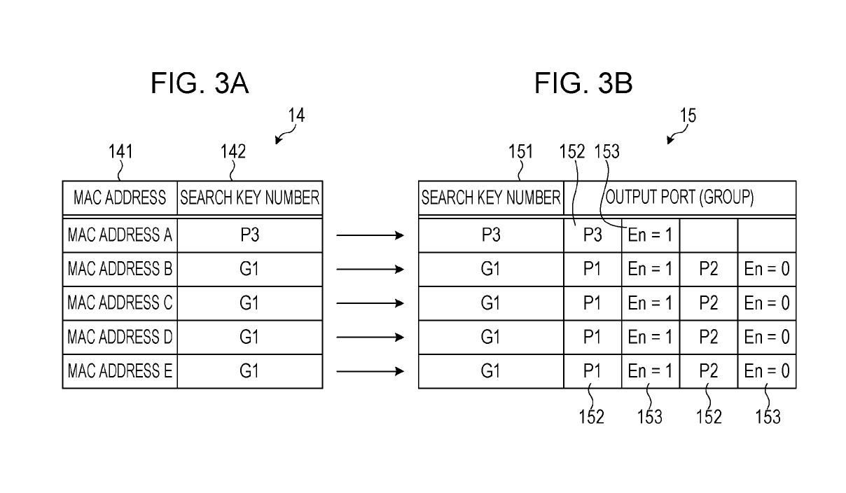

FIGS. 3A and 3B are diagrams illustrating an example of the search table 14 and an example of the output port table 15. FIGS. 3A and 3B illustrate the examples of the search table 14 and output port table 15 of the node 2A #1, for example. The search table 14 illustrated in FIG. 3A is stored in a high-speed searchable content addressable memory (CAM) in which MAC addresses 141 and search key numbers 142 are associated with each other and managed for each of entries, for example. The MAC addresses 141 are device-specific addresses identifying the terminal devices 4 included in the transmission system 1. For example, a MAC address “A” is the MAC address of the terminal device 4A. A MAC address “B” is the MAC address of the terminal device 4B. A MAC address “C” is the MAC address of the terminal device 4C. A MAC address “D” is the MAC address of the terminal device 4D. A MAC address “E” is the MAC address of the terminal device 4E.

The terminal device 4A illustrated in FIG. 1 and having the MAC address “A” is connected to the port P3 included in the node 2A #1. Thus, in the search table 14, a port number P3 is associated with the MAC address “A” and registered as a search key number 142 in the search table 14. The terminal devices 4B to 4E having the MAC addresses “B” to “E” are connected to the nodes 2, respectively, while the nodes 2 are connected to each other in the network configured in the ring topology identified by the group number G1. In the search table 14, the group number G1 is associated with the MAC addresses “B” to “E” and registered as search key numbers 142.

In the output port table 15 illustrated in FIG. 3B, output port numbers 152 and Enable (En) bits 153 are associated with search key numbers 151 corresponding to the search key numbers 142 included in the search table 14 and are managed. The output port table 15 is stored in a static random access memory (SRAM) or the like, for example. The output port numbers 152 are port numbers identifying output ports P from which received frames are transferred to the terminal devices 4 having the MAC addresses. When a search key number 151 is a port number, an output port number 152 associated with the search key number 151 is a port number identifying an output port from which a received frame is transferred. When search key numbers 151 are a group number, output port numbers 152 associated with the search key numbers 151 are port numbers identifying output ports forming a redundant configuration and connected in a ring topology corresponding to the group number. The En bits 153 indicate operational states of the output ports P. When an output port P is operating, the En bit 153 associated with the output port P is set at “1”. When an output port P stands by, the En bit 153 associated with the output port P is set at “0”.

For example, as illustrated in FIG. 3B, for the terminal device 4A having the MAC address “A”, an output destination of a frame is the output port P3 included in the node 2A #1. The controller 16 associates the port number P3 and an En bit “1” with a search key number 151 corresponding to the MAC address “A” and registers the port number P3 and the En bit “1” in the output port table 15. For the terminal devices 4B to 4E having the MAC addresses “B” to “E”, output destinations of frames are the output ports P1 and P2 that are included in the node 2A #1 and form a redundant configuration. The controller 16 registers port numbers P1 and En bits “1” for search key numbers 151 corresponding to the MAC addresses “B” to “E” in the output port table 15, and registers port numbers P2 and En bits “0” for the search key numbers 151 corresponding to the MAC addresses “B” to “E” in the output port table 15. Since the En bits 153 associated with the port numbers P1 indicate “1”, the output port corresponding to the port numbers P1 is operating. Since the En bits 153 associated with the port numbers P2 indicate “0”, the output port corresponding to the port numbers P2 stands by.

The controller 16 includes a detector 16A, an updating unit 16B, a transferring unit 16C, and an executor 16D. The detector 16A detects a failure. The updating unit 16B updates the contents of the search table 14 and the contents of the output port table 15. The transferring unit 16C references the search table 14 and the output port table 15, and transfers a received frame to an output port corresponding to a MAC-DA included in the received frame. When the detector 16A detects a failure, the executor 16D references the search table 14 and the output port table 15, and executes flooding on output ports forming a redundant configuration and connected in a failed ring topology.

When a MAC-SA included in the received frame does not exist in the search table 14 upon newly executed learning, the updating unit 16B associates the MAC address and a search key number with each other and registers the MAC address and the search key number in the search table 14, based on setting port information, an input port number of the received frame, and the MAC-SA. The setting port information corresponds to port information set for each of the nodes 2, indicates a group number identifying the network connected to each of the nodes 2, and indicates output ports P1 and P2, included in each of the nodes 2, forming a redundant configuration in which the output ports P1 are set to operating states and the output ports P2 are set to standby states upon initial setting. The updating unit 16B registers, in the output port table 15, the output port numbers 152 identifying the output ports P and the En bits 153, in association with the search key numbers 151 corresponding to the MAC addresses.

When detecting a received frame during an operation, the controller 16 extracts a MAC-SA, a MAC-DA, and an input port number from the received frame through the extractor 12, and acquires a search key number 142 associated with the extracted MAC-DA from the search table 14. In addition, the controller 16 searches the output port table 15 for output port numbers 152 associated with a search key number 151 and En bits 153 associated with the search key number 151. Furthermore, the controller 16 searches the searched output port numbers 152 for an output port number 152 associated with an En bit 153 indicating “1”. The transferring unit 16C included in the controller 16 sets, in the switch 13, the output port number 152 associated with the En bit 153 indicating “1”.

When the detector 16A detects information on a failure, the controller 16 recognizes a group number corresponding to the failure from the failure information, and searches the search key numbers 142 included in the search table 14 for the group number corresponding to the failure. In addition, the updating unit 16B searches the output port table 15 for an output port number 152 associated with the group number which is set as a search key number 151 and corresponds to the failure, and sets an En bit 153 associated with the searched output port number 152 at “0”. All the contents of a learning table are deleted in a conventional technique. In the embodiment, an entry of the output port number 152 associated with the group number corresponding to the failure remains, and only the En bit 153 associated with the output port number 152 in the remained entry is set at “0”, without deleting all the contents of the learning table as in a conventional technique. The executor 16D included in the controller 16 executes the flooding on only an output port P of the output port number 152 which is associated with the group number corresponding to the failure and whose En bit 153 indicates “0”. As a result, a range to be subjected to the flooding is suppressed to the minimum range. Then, the controller 16 updates En bits 153 associated with output port numbers 152 included in the output port table 15 based on learning results obtained based on the flooding executed by the respective nodes 2.

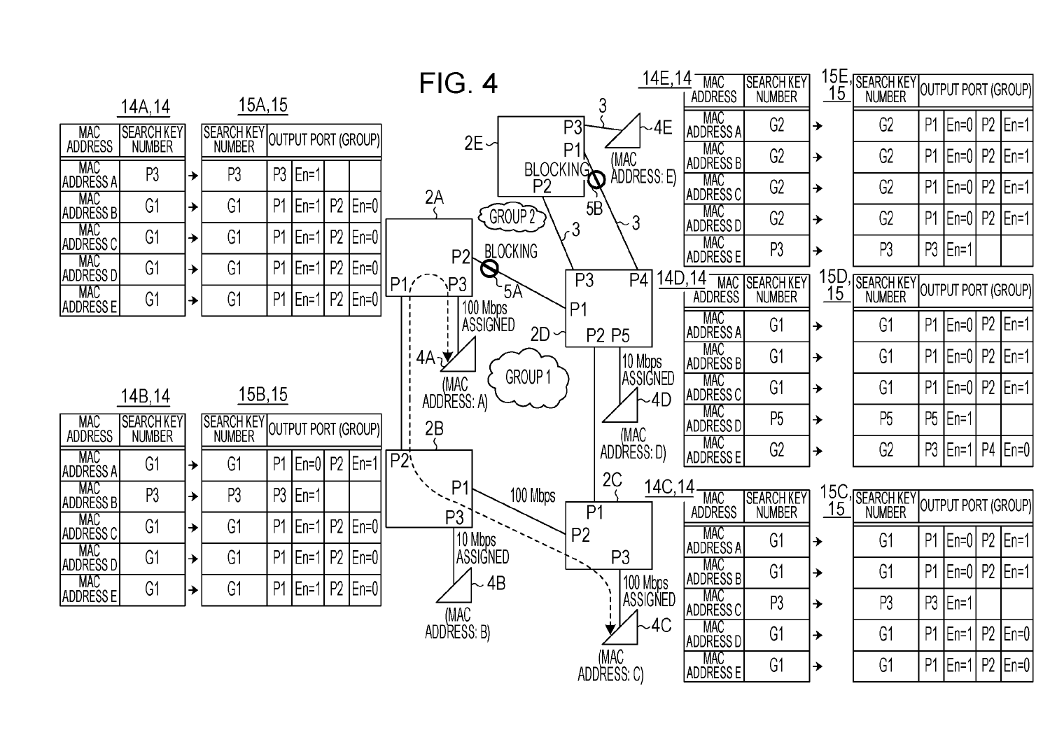

Next, operations of the transmission system 1 according to the embodiment are described. FIG. 4 is a diagram illustrating an example of the transmission system 1 that is operating. The transmission system 1 illustrated in FIG. 4 is in a normally operating state. In a search table 14A included in the node 2A #1 and illustrated in FIG. 4, a search key number 142 associated with the MAC address “A” is set to the port number P3, and search key numbers 142 associated with the MAC addresses “B” to “E” are set to the group number G1. In an output port table 15A of the node 2A #1, an output port number 152 associated with the MAC addresses “A” is set at the port number P3, and an En bit 153 associated with the MAC address “A” is set at “1”. In addition, in the output port table 15A, output port numbers 152 associated with the MAC addresses “B” to “E” are set at the port numbers P1 and P2; En bits 153 associated with the port numbers P1 are set at “1”; and En bits 153 associated with the port numbers P2 are set at “0”.

In a search table 14B of the node 2B #2, a search key number 142 associated with the MAC address “B” is set at the port number P3, and search key numbers 142 associated with the MAC addresses “A” and “C” to “E” are set at the group number G1. In an output port table 15B of the node 2B #2, an output port number 152 associated with the MAC address “B” is set at the port number P3, and an En bit 153 associated with the MAC address “B” is set at “1”. In the output port table 15B, output port numbers 152 associated with the MAC address “A” are set at the port numbers P1 and P2; an En bit 153 associated with the port number P1 and the MAC address “A” is set at “0”; and an En bit 153 associated with the port number P2 and the MAC address “A” is set at “1”. In addition, in the output port table 15B, output port numbers 152 associated with the MAC addresses “C” to “E” are set at the port numbers P1 and P2; En bits 153 associated with the port numbers P1 and the MAC addresses “C” to “E” are set at “1”; and En bits 153 associated with the port numbers P2 and the MAC addresses “C” to “E” are set at “0”.

In a search table 14C of the node 2C #3, a search key number 142 associated with the MAC address “C” is set at the port number P3, and search key numbers 142 associated with the MAC addresses “A”, “B”, “D”, and “E” are set at the group number G1. In an output port table 15C of the node 2C #3, an output port number 152 associated with the MAC address “C” is set at the port number P3, and an En bit 153 associated with the MAC address “C” is set at “1”. In the output port table 15C, output port numbers 152 associated with the MAC addresses “A” and “B” are set at the port numbers P1 and P2; En bits 153 associated with the port numbers P1 and the MAC addresses “A” and “B” are set at “0”; and En bits 153 associated with the port numbers P2 and the MAC addresses “A” and “B” are set at “1”. In addition, in the output port table 15C, output port numbers 152 associated with the MAC addresses “D” and “E” are set at the port numbers P1 and P2; En bits 153 associated with the port numbers P1 and the MAC addresses “D” and “E” are set at “1”; and En bits 153 associated with the port numbers P2 and the MAC addresses “D” and “E” are set at “0”.

In a search table 14D of the node 2D #4, a search key number 142 associated with the MAC address “D” is set at a port number P5, and search key numbers 142 associated with the MAC addresses “A” to “C” are set at the group number G1. In the search table 14D, a search key number 142 associated with the MAC address “E” is set at the group number G2. The node 2E connected to the terminal device 4E is not connected in the ring topology of the group number G1 and is thus classified into the group number G2. In an output port table 15D of the node 2D #4, an output port number 152 associated with the MAC address “D” is set at the port number P5, and an En bit 153 associated with the MAC address “D” is set at “1”. In the output port table 15D, output port numbers 152 associated with the MAC addresses “A” to “C” are set at the port numbers P1 and P2; En bits 153 associated with the port numbers P1 and the MAC addresses “A” to “C” are set at “0”; and En bits 153 associated with the port numbers P2 and the MAC addresses “A” to “C” are set at “1”. In addition, in the output port table 15D, output port numbers 152 associated with the MAC address “E” are set at the port numbers P3 and P4; an En bit 153 associated with the port number P3 and the MAC address “E” is set at “1”; and an En bit 153 associated with the port number P4 and the MAC address “E” is set at “0”.

In a search table 14E of the node 2E #5, a search key number 142 associated with the MAC address “E” is set at the port number P3, and search key numbers 142 associated with the MAC addresses “A” to “D” are set at the group number G2. In an output port table 15E of the node 2E #5, an output port number 152 associated with the MAC address “E” is set at the port number P3, and an En bit 153 associated with the MAC address “E” is set at “1”. In the output port table 15E, output port numbers 152 associated with the MAC addresses “A” to “D” are set at the port numbers P1 and P2; En bits 153 associated with the port numbers P1 and the MAC addresses “A” to “D” are set at “0”; and En bits 153 associated with the port numbers P2 and the MAC addresses “A” to “D” are set at “1”.

In the example illustrated in FIG. 4, the terminal device 4A communicates with the terminal device 4C through the nodes 2A #1, 2B #2, and 2C #3. For example, when detecting a frame received from the terminal device 4C and to be directed to the terminal device 4A, the controller 16 included in the node 2A #1 extracts, through the extractor 12, a MAC-SA, a MAC-DA, and an input port number that are included in the received frame. The MAC-SA is the MAC address “C” of the terminal device 4C, and the MAC-DA is the MAC address “A” of the terminal device 4A, for example. The controller 16 acquires, from the search table 14, a search key number 142 associated with the extracted MAC-DA (MAC address “A”). The search key number 142 is the output port number P3, for example. The controller 16 searches, from the output port table 15, output port numbers 152 and En bits 153 that are associated with a search key number 151 corresponding to the search key number 142. The output port numbers 152 are the output port numbers P3, and the En bits 153 are “1”, for example. The controller 16 searches the searched output port numbers 152 for an output port number 152 associated with an En bit 153 indicating “1”. The transferring unit 16C included in the controller 16 sets, in the switch 13, the output port number 152 associated with the En bit 153 indicating “1”. Specifically, after setting the output port number P3 in the switch 13, the transferring unit 16C transfers the frame received from the terminal device 4C to the output port P3 of the output port number P3 and transfers the frame to the terminal device 4A through the output port P3.

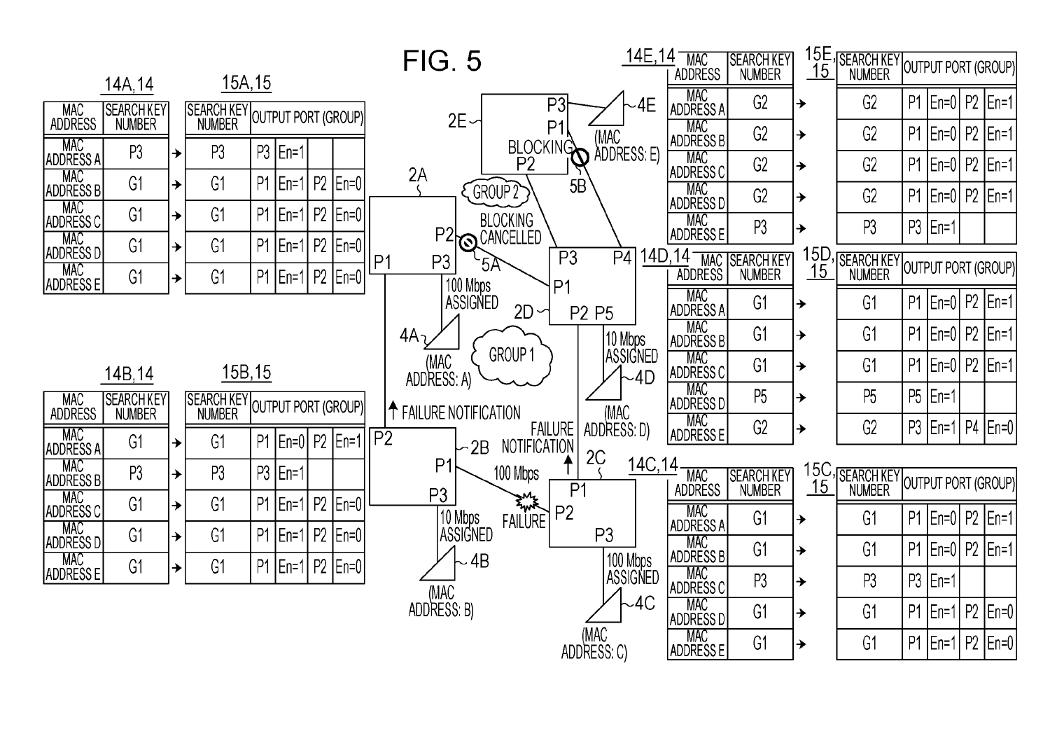

FIG. 5 is a diagram illustrating an example of the transmission system 1 when a failure occurs. The example illustrated in FIG. 5 assumes that the failure occurs on the transmission path 3 between the node 2B #2 and the node 2C #3. The node 2B #2 and the node 2C #3 recognize that the failure occurs in the ring topology of the group number G1. The node 2B #2 notifies the node 2A #1 of information of the failure. When detecting the failure information received from the node 2B #2, the node 2A #1 recognizes that the failure occurs in the ring topology of the group number G1. In addition, the node 2C #3 notifies the node 2D #4 of the failure information. When detecting the failure information received from the node 2C #3, the node 2D #4 recognizes that the failure occurs in the ring topology of the group number G1. Details of the search tables 14 and output port tables 15 of the nodes 2A to 2E upon the detection of the failure are the same as the details illustrated in FIG. 4.

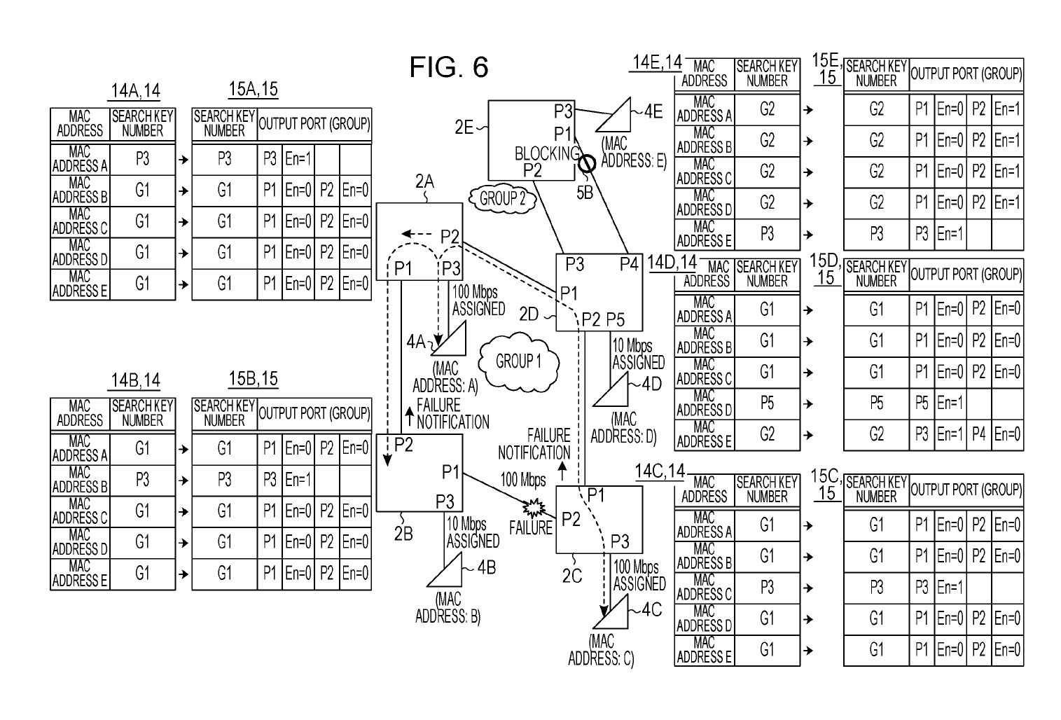

FIG. 6 is a diagram illustrating an example of the transmission system 1 when the failure is detected. In the example illustrated in FIG. 6, when detecting the failure information through the detectors 16A, the controllers 16 included in the nodes 2A #1 to 2D #4 recognize the group number G1 corresponding to the failure from the failure information, and search the search key numbers 142 included in the search tables 14 for the group number G1 corresponding to the failure. In addition, the updating units 16B included in the controllers 16 search the output port tables 15 for output port numbers 152 associated with the group number G1 that is set as search key numbers 151 and is corresponding to the failure. Then, the updating units 16B set En bits 153 associated with the searched output port numbers 152 at “0”.

In the output port table 15A of the node 2A #1, the output port number 152 and the En bit 153 that are associated with the MAC address “A” are maintained, and all the En bits 153 that are associated with the port numbers P1 and P2 associated with the group number G1 and the MAC addresses “B” to “E” are set at “0”. In the output port table 15B of the node 2B #2, the output port number 152 and the En bit 153 that are associated with the MAC address “B” are maintained and all the En bits 153 that are associated with the port numbers P1 and P2 associated with the group number G1 and the MAC addresses “A” and “C” to “E” are set at “0”.

In the output port table 15C of the node 2C #3, the output port number 152 and the En bit 153 that are associated with the MAC address “C” are maintained. In the output port table 15C, all the En bits 153 that are associated with the port numbers P1 and P2 associated with the group number G1 and the MAC addresses “A”, “B”, “D”, and “E” are set at “0”. In the output port table 15D of the node 2D #4, the output port numbers 152 and En bits 153 that are associated with the MAC addresses “D” and “E” are maintained. In the output port table 15D, all the En bits 153 that are associated with the port numbers P1 and P2 associated with the group number G1 and the MAC addresses “A”, “B”, and “C” are set at “0”.

In the output port table 15E of the node 2E #5, the output port numbers 152 and En bits 153 that are associated with the MAC addresses “A” to “E” are maintained.

The executors 16D included in the controllers 16 of the nodes 2A #1 to 2D #4 execute flooding on only output ports P of the output port numbers 152 that are associated with the En bits 153 indicating “0” and are associated with the group number G1 corresponding to the failure. Specifically, the nodes 2A #1 to 2D #4 execute the flooding on the output ports of the output port numbers associated with the group number G1. Since the node 2E #5 is not included in the topology identified by the group number G1, the node 2E #5 does not execute flooding. As a result, a range to be subjected to the flooding may be suppressed to the minimum range. Then, the controllers 16 update the En bits 153 associated with the output port numbers 152 included in the output port tables 15, based on learning results obtained from the flooding executed by the nodes 2.

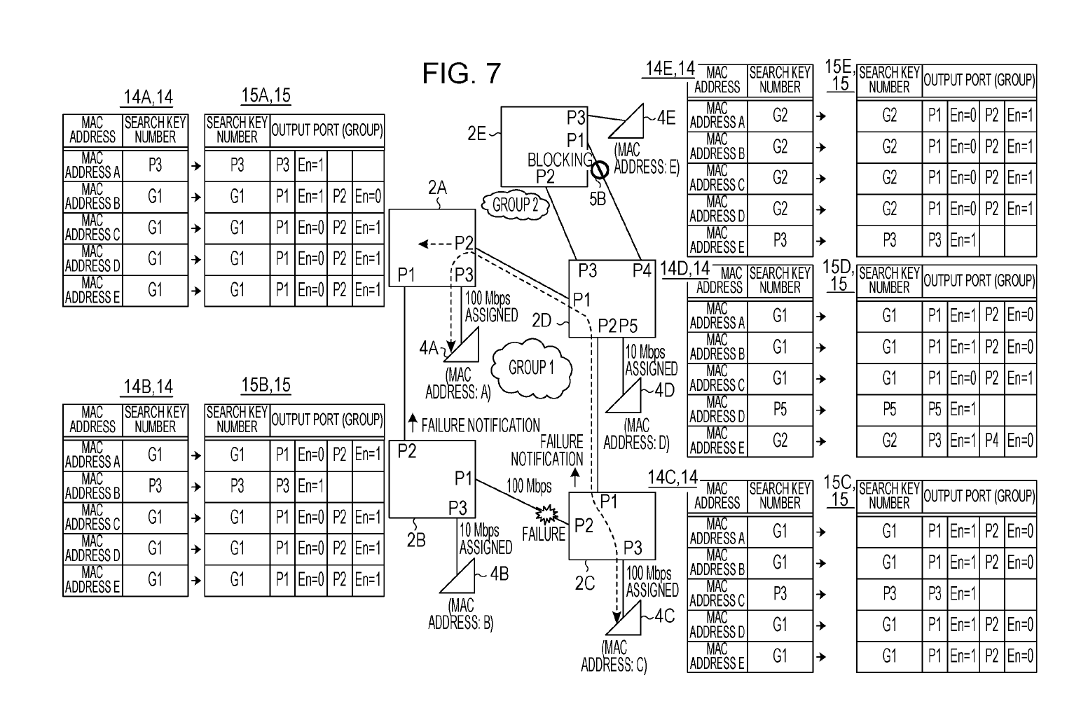

FIG. 7 is a diagram illustrating an example of the transmission system 1 after execution of the flooding. In the example illustrated in FIG. 7, the nodes 2A #1 to 2D #4 update the contents of the output port tables 15 in a process of learning received frames caused by the execution of the flooding.

In the output port table 15A, illustrated in FIG. 7, of the node 2A #1, the En bit 153 of the port number P1 associated with the group number G1 and the MAC address “B” is set at “1”; and the En bits 153 of the port numbers P2 associated with the MAC addresses “C” to “E” are set at “1”. In the output port table 15B of the node 2B #2, the En bits 153 of the port numbers P2 associated with the group number G1 and the MAC addresses “A” and “C” to “E” are set at “1”.

In the output port table 15C of the node 2C #3, the En bits 153 of the port numbers P1 associated with the group number G1 and the MAC addresses “A”, “B, “D”, and “E” are set at “1”. In the output port table 15D of the node 2D #4, the En bits 153 of the port numbers P1 associated with the group number G1 and the MAC addresses “A” and “B” are set at “1”. In addition, in the output port table 15D, the En bit 153 of the port number P2 associated with the group number G1 and the MAC address “C” is set at “1”. In the output port table 15E of the node 2E #5, the En bits 153 and output port numbers 152 that are associated with the MAC addresses “A” to “E” are not changed. As a result, the nodes 2A to 2D of the group number G1 learn and update the contents of the output port tables 15, based on changes in paths due to the execution of the flooding.

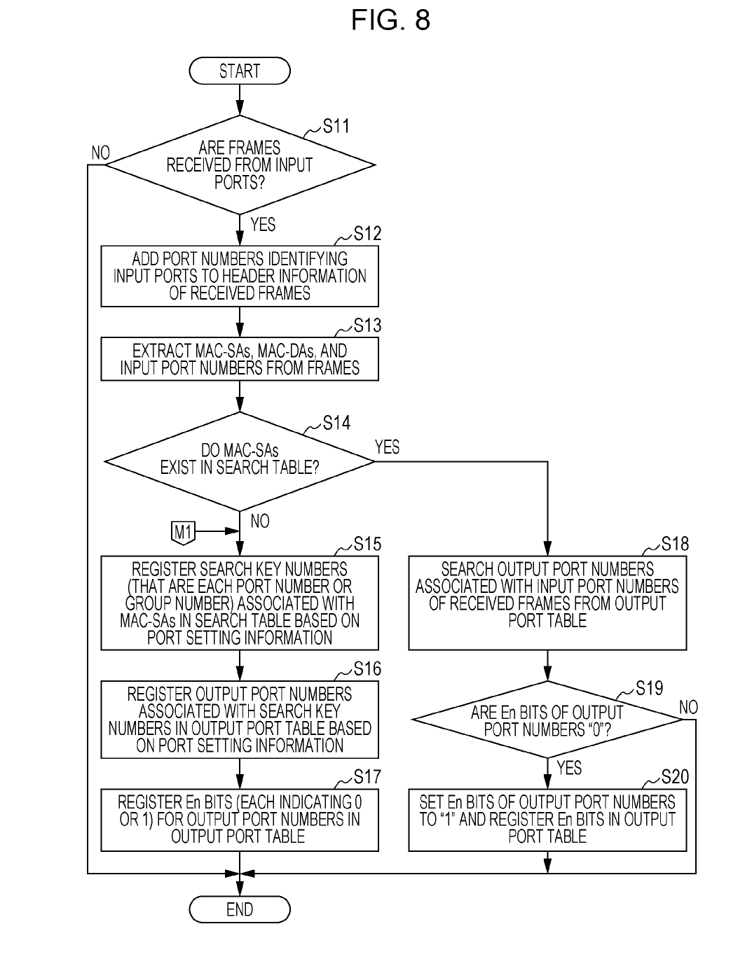

FIG. 8 is a flowchart of an example of operations of a node 2 that are related to the learning process. The learning process illustrated in FIG. 8 is a process of learning and updating contents of the search table 14 and contents of the output port table 15.

Referring to FIG. 8, the controller 16 included in the node 2 determines whether or not the node 2 receives a frame from an input port P through the MUX 11 (in step S11). When the MUX 11 receives the frame (Yes in step S11), the MUX 11 adds a port number identifying the input port P to header information of the received frame (in step S12).

The extractor 12 included in the node 2 extracts a MAC-SA, a MAC-DA, and an input port number from the received frame (in step S13). The controller 16 included in the node 2 determines whether or not the extracted MAC-SA exists in the search table 14 (in step S14). When the extracted MAC-SA does not exist in the search table 14 (No in step S14), the updating unit 16B newly registers a search key number 142 associated with the MAC address 141 (MAC-SA) in the search table 14 (in step S15).

After associating the search key number 142 with the MAC-SA and registering the search key number 142 in the search table 14, the updating unit 16B newly registers output port numbers 152 associated with the search key numbers 142 (151) in the output port table 15 (in step S16). After registering the output port numbers 152 associated with the search key number 151 in the output port table 15, the updating unit 16B newly registers En bits 153 for the output port numbers 152 in the output port table 15 (in step S17), and terminates the process illustrated in FIG. 8. As a result, when the MAC-SA included in the received frame is new, the controller 16 may newly register the output port numbers 152 and En bits 153 associated with the MAC-SA included in the received frame.

When the MAC-SA exists in the search table 14 (Yes in step S14), the controller 16 searches the output port table 15 for output port numbers 152 associated with the input port number included in the received frame (in step S18). The controller 16 determines whether or not an En bit 153 associated with the searched output port number 152 is “0” (in step S19). When the En bit 153 associated with the output port number 152 is “0” (Yes in step S19), the updating unit 16B sets the En bit 153 associated with the output port number 152 at “1”, registers the En bit 153 in the output port table 15 (in step S20), and terminates the process illustrated in FIG. 8. As a result, when the MAC-SA included in the received frame is already registered, the controller 16 may update and register the output port numbers 152 and En bits 153 associated with the input port number included in the received frame by means of flooding.

When the En bit 153 associated with the output port number 152 is not “0” (No in step S19), the controller 16 terminates the process illustrated in FIG. 8. When the node 2 does not receive the frame (No in step S11), the controller 16 terminates the process illustrated in FIG. 8.

When the MAC-SA included in the received frame does not exist in the search table 14, the controller 16 that executes the learning process registers, in the output port table 15, based on the port setting information, En bits 153 and output port numbers 152 for output ports that form a redundant configuration and are associated with the MAC-SA. As a result, the controller 16 may learn and newly register the output port numbers 152 and the En bits 153 for each of the MAC-SAs.

When the MAC-SA included in the received frame exists in the search table 14, the controller 16 searches the output port table 15 for the output port numbers 152 associated with the input port number included in the received frame. In addition, when En bits 153 of the output port numbers 152 are “0”, the controller 16 performs learning registration by setting the En bits 153 of the output port numbers 152 at “1”, and registering the En bits 153 in the in the output port table 15. As a result, the controller 16 may update, by executing the flooding, the output port table 15 to contents reflecting the result of the learning registration corresponding to the latest changes in paths.

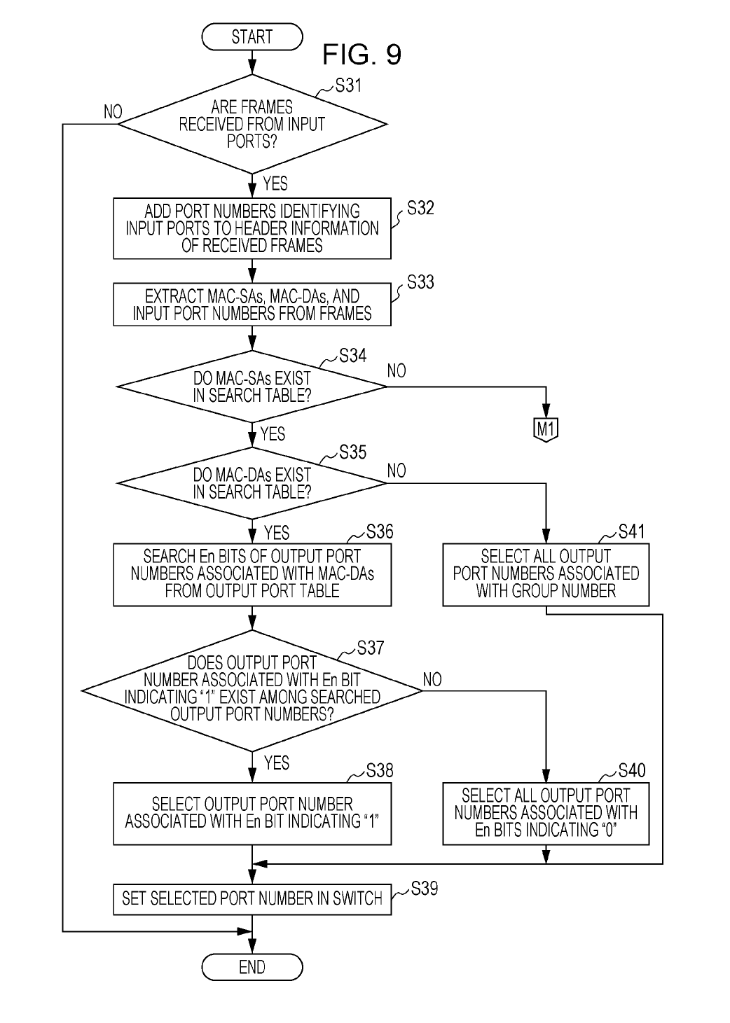

FIG. 9 is a flowchart of an example of operations of a node 2 that are related to an operation process. The operation process illustrated in FIG. 9 is a process of referencing the search table 14 and the output port table 15, referencing En bits 153 of output port numbers 152 associated with MAC-DAs included in received frames, and transferring the received frames to output ports of output port numbers associated with En bits 153 indicating “1”.

Referring to FIG. 9, the controller 16 included in the node 2 determines whether or not the node 2 receives a frame from input ports P through the MUX 11 (in step S31). When the MUX 11 receives the frame (Yes in step S31), the MUX 11 adds a port number identifying the input port P to header information of the received frame (in step S32).

The extractor 12 extracts a MAC-SA, a MAC-DA, and an input port number from the received frame (in step S33). The controller 16 determines whether or not the extracted MAC-SA exists in the search table 14 (in step S34). When the extracted MAC-SA does not exist in the search table 14 (No in step S34), the controller 16 causes the process to proceed to M1 illustrated in FIG. 8 in order to register search key number 142 associated with the MAC-SA (MAC addresses 141) in the search table 14.

When the extracted MAC-SA exists in the search table 14 (Yes in step S34), the controller 16 determines whether or not the extracted MAC-DA exists in the search table 14 (in step S35). When the extracted MAC-DA exists in the search table 14 (Yes in step S35), the controller 16 searches the output port table 15 for En bits 153 of output port numbers 152 associated with the search key number 151 of the MAC-DA (in step S36).

The controller 16 determines whether or not an output port number associated with an En bit 153 indicating “1” exists among the searched output port numbers 152 (in step S37). When the output port number 152 associated with the En bit 153 indicating “1” exists (Yes in step S37), the transferring unit 16C included in the controller 16 selects the output port number 152 associated with the En bit 153 indicating “1” (in step S38). In addition, the transferring unit 16C sets the selected output port number 152 to the switch 13 (in step S39) and terminates the process illustrated in FIG. 9.

When the output port number associated with the En bit 153 indicating “1” does not exist among the searched output port numbers 152 (No in step S37), the transferring unit 16C selects all output port numbers 152 associated with En bits 153 indicating “0” (in step S40). The transferring unit 16C causes the process to proceed to step S39 in order to set the selected output port numbers 152 to the switch 13.

When the extracted MAC-DA does not exist in the search table 14 (No in step S35), the transferring unit 16C selects all output port numbers 152 associated with the group number set as a search key number 151 (in step S41). The transferring unit 16C causes the process to proceed to step 39 in order to set the selected output port numbers 152 to the switch 13.

When the MUX 11 does not receive a frame from the input port P (No in step S31), the controller 16 terminates the process illustrated in FIG. 9.

The controller 16 that executes the operation process illustrated in FIG. 9 sets, in the switch 13, an output port number that is associated with an En bit 153 indicating “1” and is among output port numbers 152 associated with the MAC-DA included in the received frame and existing in the search table 14. This allows the node 2 to transfer the received frame to output port corresponding to the MAC-DA included in the received frame.

When the output port number that is associated with the En bit 153 indicating “1” does not exist among the output port numbers 152 associated with the MAC-DA, the controller 16 sets, in the switch 13, all output port numbers 152 which are associated with the MAC-DA and whose En bits 153 indicate “0”. This allows the node 2 to transfer the received frame to each of output ports forming a redundant configuration.

When the MAC-DA does not exist in the search table 14, the controller 16 sets, in the switch 13, output port numbers 152 of all output ports related to the group number set in search key numbers 151. This allows the node 2 to transfer the received frame to each of the output ports that form the redundant configuration and are identified by the output port numbers associated with the group number.

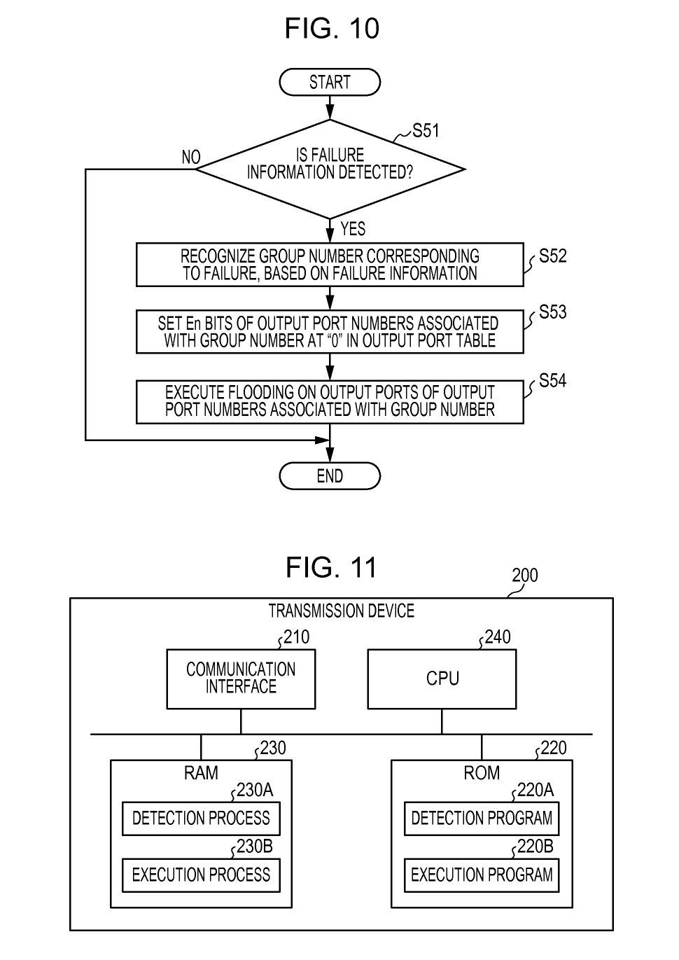

FIG. 10 is a flowchart of an example of operations of a node 2 that are related to a process of detecting a failure. The failure detection process illustrated in FIG. 10 is a process of setting, at “0”, all En bits 153 of output port numbers 152 associated with a group number corresponding to a failure and executing the flooding on output ports of the output port numbers associated with the En bits 153 indicating “0”.

Referring to FIG. 10, the controller 16 included in the node 2 determines whether or not the controller 16 detects information of a failure through the detector 16A (in step S51). When the controller 16 detects the failure information (Yes in step S51), the controller 16 recognizes a group number corresponding to the failure, based on the failure information (in step S52). After recognizing the group number corresponding to the failure, the updating unit 16B sets En bits 153 of output port numbers 152 associated with search key numbers 151 (each indicating the group number) at “0” in the output port table 15 and registers the set En bits 153 in the output port table 15 (in step S53). In addition, the executor 16D included in the controller 16 executes the flooding on all the output ports P which are identified by the output port numbers 152 associated with the group number corresponding to the failure and whose En bits 153 indicate “0” (in step S54) and terminates the process illustrated in FIG. 10.

When the controller 16 does not detect the failure information (No in step S51), the controller 16 terminates the process illustrated in FIG. 10.

When detecting information of a failure, the controller 16, which executes the failure detection process illustrated in FIG. 10, recognizes a group number corresponding to the failure indicated in the failure information, and sets En bits 153 of output port numbers 152 associated with the group number corresponding to the failure at “0”. In addition, after setting the En bits 153 of the output port numbers 152 at “0”, the controller 16 executes the flooding on output ports identified by the output port numbers associated with the En bits 153 indicating “0”. As a result, the En bits 153 of output port numbers 152 associated with a group number corresponding to a failure are set at “0” with remaining entries of output port numbers 152 and En bits 153 without deleting all the contents of a learning table as in the conventional technique. In addition, since the flooding is executed on the output ports identified by the output port numbers 152 that are associated with the group number corresponding to the failure and are associated with En bits 153 indicating “0”, a range to be subjected to the flooding is suppressed to the minimum range. In addition, by suppressing the range to be subjected to the flooding, discarding in the transmission path 3 in the transmission system 1, to which a low bit rate is assigned, may be suppressed and interruption of communication may be prevented.

Each of the nodes 2 according to the embodiment manages, for each of MAC addresses, port numbers 152 of output ports that form a redundant configuration and from which received frames are transferred, and manages En bits 153 for the output ports. When detecting a failure, the node 2 executes the flooding on only output ports that are related to a failed ring topology and form a redundant configuration. As a result, a range to be subjected to the flooding may be suppressed to the minimum range, in other words, to the failed ring topology, or to output ports associated with the group number corresponding to the failure. In addition, by suppressing the range to be subjected to the flooding, discarding in the transmission path 3, to which a low bit rate is assigned and which is included in the transmission system 1, may be suppressed and interruption of communication may be prevented. As a result, by preventing interruption of communication, the techniques disclosed herein may be effectively used for communication frames to be used to transfer data for which a mechanism for avoiding instantaneous interruption of communication is requested, such as images and audio data.

When receiving a frame, the nodes 2 transfer the received frame to output ports identified by output port numbers that are associated with MAC-DA included in the received frame and are associated with En bits 153 indicating “1”. As a result, the nodes 2 may easily transfer the received frames to destinations.

When detecting a failure, each of the nodes 2 sets, at “0”, En bits 153 associated with output port numbers of output ports that are related to a ring topology of a group number indicated in information of the failure and form a redundant configuration, and executes the flooding on the output ports associated with the En bits 153 indicating “0”. As a result, a range to be subjected to the flooding may be suppressed to the minimum range.

In the embodiment, the number of output ports included in each of the nodes 2 and forming a redundant configuration is 2, but is not limited to 2. In the embodiment, the number of the nodes 2 included in the transmission system 1 is 5, but is not limited to 5.

In the embodiment, when entries included in the search table 14 and the output port table 15 are not used for a certain time period, an aging process may be executed.

In the embodiment, the transmission path 3 for transferring communication frames of electric signals is exemplified, but an optical transmission path for transferring communication frames of optical signals may be used. In this case, the nodes 2 are optical transfer devices.

When detecting information of a failure, each of nodes 2 according to the embodiment executes the flooding on output ports that are connected in a ring topology identified by a group number corresponding to the failure and form a redundant configuration. The embodiment, however, is not limited to the failure information. For example, the techniques disclosed herein is applicable to the case of detecting switching information indicating that a path is changed in the ring topology identified by the group number or that a path is changed due to update of information of the ring topology.

The constituent elements of the units illustrated in the drawings may not be physically configured as illustrated in the drawings. Specifically, specific forms of the separation and integration of the units are not limited to the forms illustrated in the drawings, and all or a part of the elements may be functionally or physically separated or integrated, on an arbitrary basis, based on loads of the elements and usage statuses of the elements.

The transmission devices each include a central processing unit (CPU), a digital signal processor (DSP), and a memory. Each of the memories may be a read only memory (ROM) or a random access memory (RAM), such as a synchronous dynamic random access memory (SDRAM), a magnetoresistive random access memory (MRAM), or a nonvolatile random access memory (NRAM). All or an arbitrary part of various process functions to be executed by the devices, for example, process functions of the controllers 16 and the like, may be executed on the CPUs or the DSPs. All or a part of the various process functions may be executed on a program to be analyzed and executed by the CPUs or the DSPs or may be executed on hardware configured by wired logic.

The various processes that are described in the embodiment may be achieved by causing each of processors, such as the CPUs included in the transmission devices, to execute a program prepared in advance. An example of the transmission devices that execute the program having the same functions as those described in the embodiment is described below. FIG. 11 is a diagram illustrating an example of the transmission devices that execute the transmission program.

A transmission device 200 illustrated in FIG. 11 that executes the transmission program includes a communication interface 210, a ROM 220, a RAM 230, and a CPU 240. The communication interface 210, the ROM 220, the RAM 230, and the CPU 240 are connected to each other through a bus.

The ROM 220 has, stored therein, the transmission program that achieves the same functions as those described in the embodiment. The ROM 220 has, as the transmission program, a detection program 220A and an execution program 220B stored therein. The transmission program may not be stored in the ROM 220 and may be stored in a computer-readable recording medium that is read by a drive (not illustrated). As the recording medium, a portable recording medium such as a CD-ROM, a DVD, or a USB memory, a semiconductor memory such as a flash memory, or the like may be used.

The CPU 240 reads the detection program 220A from the ROM 220 and thereby functions as a detection process 230A on the RAM 230. In addition, the CPU 240 reads the execution program 220B from the ROM 220 and thereby functions as an execution process 230B on the RAM 230. The communication interface 210 has a plurality of ports that are connected to other transmission devices in a system configured in a ring topology. The RAM 230 stores a table to be used to manage, for each of destination information items, port information items identifying a plurality of output ports that are connected in the ring topology and configured to transfer communication signals and form a redundant configuration.

The CPU 240 detects switching information in the system. When detecting the switching information, the CPU 240 references the table and executes the flooding on output ports related to port information items which indicate a redundant configuration connected in a ring topology indicated by the switching information. As a result, a range to be subjected to the flooding may be suppressed to the minimum range.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission device connected to other transmission devices in a system configured in a ring topology, the transmission device comprising:
a memory configured to store port information items identifying a plurality of output ports connected in the ring topology, in association with each of destination information items, the plurality of output ports forming a redundant configuration and each being configured to transfer a communication signal; and
a processor configured:
to detect switching information in the system which indicates the port information items related to a change in paths of the ring topology, and
to, with reference to the memory, execute flooding on first output ports associated with the port information items, indicated by the switching information, of the redundant configuration connected in the ring topology.

2. The transmission device of claim 1, wherein
the memory is configured to store operational states indicating whether the plurality of output ports are in operating states or standby states, in association with each of the port information items; and
the processor is configured to, upon receiving the communication signals, with reference to the memory, transfer a communication signal to second output ports which are associated with the destination information item included in the communication signal and whose operational states are operating states.

3. The transmission device of claim 1, wherein
the processor is configured to update the port information items in the memory by setting, at standby states, the operational states of the first output ports associated with the port information items, indicated by the switching information, of the redundant configuration connected in the ring topology; and
the processor, with reference to the memory, executes the flooding on the first output ports that are in standby states.

4. A transmission system comprising:
a plurality of transmission devices connected in a system configured in a ring topology, wherein
each of the transmission devices includes:
a memory configured to store port information items identifying a plurality of output ports connected in the ring topology, in association with each of destination information items, the plurality of output ports forming a redundant configuration and each being configured to transfer a communication signal; and
a processor configured:
to detect switching information in the system which indicates the port information items related to a change in paths of the ring topology, and
to, with reference to the memory, execute flooding on output ports associated with the port information items, indicated by the switching information, of the redundant configuration connected in the ring topology.

5. A method performed by a transmission device connected to other transmission devices in a system configured in a ring topology, the method comprising:
providing the transmission device with a memory configured to store port information items identifying a plurality of output ports connected in the ring topology, in association with each of destination information items, the plurality of output ports forming a redundant configuration and each being configured to transfer a communication signal; and
upon detecting switching information in the system which indicates the port information items related to a change in paths of the ring topology, executing flooding on output ports associated with the port information items, indicated by the switching information, of the redundant configuration connected in the ring topology.
